(19) United States
(12) Patent Application Publication
(10) Pub. No.: US 2010/0036053 A1
(43) Pub. Date: Feb. 11, 2010

(54) Aqueous Polymerization Process for the Manufacture of Fluoropolymer Comprising Repeating Units Arising from a Perfluoromonomer and a Monomer Having a Functional Group and a Polymerizable Carbon-Carbon Double Bond

(75) Inventors: Ralph Munson Aten, Chadds Ford, PA (US); Sharon Ann Libert, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/511,295

(22) Filed: Jul. 29, 2009

Related U.S. Application Data
(60) Provisional application No. 61/087,401, filed on Aug. 8, 2008.

(51) Int. Cl. C08L 27/12; C08F 214/18

(52) U.S. Cl. 524/805; 526/250

(57) ABSTRACT

Disclosed is an aqueous polymerization process for the manufacture of a fluoropolymer comprising repeating units arising from a perfluoromonomer and a monomer having a functional group and a polymerizable carbon-carbon double bond, comprising: (A) combining water and a perfluoromonomer to form a reaction mixture; (B) initiating polymerization of the perfluoromonomer; (C) polymerizing a portion of the perfluoromonomer to form particles of polymerized perfluoromonomer in the reaction mixture; (D) adding to the reaction mixture a monomer having a functional group and a polymerizable carbon-carbon double bond; and (E) polymerizing the perfluoromonomer and the monomer having a functional group and a polymerizable carbon-carbon double bond in the presence of the particles of polymerized perfluoromonomer to form the fluoropolymer. The fluoropolymer is useful as an adhesive and coating.

### FIELD OF THE DISCLOSURE

This disclosure relates in general to an aqueous polymerization process for the manufacture of a fluoropolymer having repeating units arising from a perfluoromonomer and a monomer having a functional group and a polymerizable carbon-carbon double bond.

### BACKGROUND

Fluorine containing polymers are important commercial products due to their low surface energy and high thermal and chemical resistance. However, often their low surface energy leads to poor adhesion to substrates.

Certain functional groups are known to modify the adhesive properties of partially fluorinated polymers. Incorporation of such groups during polymerization of partially fluorinated polymers without significantly sacrificing desirable polymer properties has been met with limited success to date. Monomers containing functional groups may not copolymerize with fluorinated monomers or may cause other undesirable effects in a copolymerization.

Aqueous polymerization processes find commercial application for the manufacture of perfluoropolymers. Such processes are preferred by industry as water is a renewable and cost-effective polymerization medium, and the processes afford fine control over the formation of perfluoropolymers having a range of desirable properties at industrially useful space-time yields. However, the art is silent as to aqueous polymerization processes for the manufacture of perfluoropolymers that contain repeating units having functional groups that result in the perfluoropolymer having adhesive properties.

Thus, there is a need for such processes.

### SUMMARY

An aqueous polymerization process for the manufacture of fluoropolymers having functional groups is described herein that meets industry needs.

Described herein is an aqueous polymerization process for the manufacture of a fluoropolymer having repeating units arising from a perfluoromonomer and a monomer having a functional group and a polymerizable carbon-carbon double bond, comprising:

(A) combining water and a perfluoromonomer to form a reaction mixture;

(B) initiating polymerization of the perfluoromonomer;

(C) polymerizing a portion of the perfluoromonomer to form particles of polymerized perfluoromonomer in the reaction mixture;

(D) adding to the reaction mixture a monomer having a functional group and a polymerizable carbon-carbon double bond wherein all monovalent atoms in said monomer having a functional group and a polymerizable carbon-carbon double bond are hydrogen; and

(E) polymerizing the perfluoromonomer and the monomer having a functional group and a polymerizable carbon-carbon double bond in the presence of the particles of polymerized perfluoromonomer to form the fluoropolymer.

The foregoing general description and the following detailed description are exemplary and explanatory only and are not restrictive of the invention, as defined in the appended claims.

### DETAILED DESCRIPTION

In an embodiment of the aqueous polymerization process, surfactant is added to the reaction mixture and the reaction mixture comprises an aqueous dispersion.

In another embodiment of the aqueous polymerization process, the reaction mixture is heated.

In another embodiment of the aqueous polymerization process, the functional group of the monomer having a functional group and a polymerizable carbon-carbon double bond is a carboxyl group.

In another embodiment of the aqueous polymerization process, the pH of the reaction mixture measured at 25° C. is less than the pKₐ of the carboxylic acid corresponding to the monomer having a carboxyl functional group and a polymerizable carbon-carbon double bond.

In another embodiment of the aqueous polymerization process, the monomer having a functional group and a polymerizable carbon-carbon double bond comprises a monomer having a dicarboxylic acid group capable of forming a cyclic dicarboxylic acid anhydride and a polymerizable carbon-carbon double bond, and the pH of the reaction mixture measured at 25° C. is less than the pKₐ₁ of the monomer having a dicarboxylic acid group capable of forming a cyclic dicarboxylic acid anhydride and a polymerizable carbon-carbon double bond.

In another embodiment of the aqueous polymerization process, the reaction mixture further comprises a strong acid.

In another embodiment of the aqueous polymerization process, the reaction mixture further comprises an acidic buffer.

In another embodiment, a fluoropolymer is manufactured by the aqueous polymerization process, wherein the perfluoromonomer comprises at least one repeating unit arising from tetrafluoroethylene, hexafluoropropylene, and perfluoro(alkyl vinyl ether), and wherein the functional group of the monomer having a functional group and a polymerizable carbon-carbon double bond is at least one selected from the group consisting of carboxyl, amine, amide, hydroxyl, phosphonate, sulfonate, nitrile, boronate and epoxide.

In another embodiment, fluoropolymer manufactured by the aqueous polymerization process is melt processible.

Embodiments described above and are merely exemplary and not limiting. After reading this specification, skilled artisans appreciate that other aspects and embodiments are possible without departing from the scope of the invention.

Other features and benefits of any one or more of the embodiments will be apparent from the following detailed description, and from the claims. The detailed description first addresses

1. Definitions and Clarification of Terms, followed by:

2. Perfluoromonomer;

3. Monomer Having A Functional Group and a Polymerizable Carbon-Carbon Double Bond (FG);

4. FG-fluoropolymer Melting Point and Melt Flow Rate;

5. Combining Water and a Perfluoromonomer to form a Reaction Mixture (A);

6. Initiating Polymerization of the Perfluoromonomer (B);

7. Polymerizing a Portion of the Perfluoromonomer to form Particles of Polymerized Perfluoromonomer (C);

8. Adding to the Reaction Mixture a Monomer having a Functional Group and a Polymerizable Carbon-Carbon Double Bond (D);

9. pH of the Reaction Mixture;

10. FG-Fluoropolymer Produced by the Present Process;

11. Optional Monomers;

12. Utility of FG-fluoropolymer Produced by the Present Process; and Examples.

### 1. Definitions and Clarification of Terms

Before addressing further details of these embodiments, some terms are defined or clarified.

By semicrystalline is meant that the fluoropolymer has some crystallinity and is characterized by a detectable melting point measured according to ASTM D 4501, and a melting endotherm of at least about 3 J/g. Semicrystalline fluoropolymers are distinguished from amorphous fluoropolymers.

By melt processible is meant that the fluoropolymer can be processed using conventional plastic processing techniques, such as melt extrusion.

Polymer described herein as containing repeating units arising from a perfluoromonomer and a hydrocarbon monomer having a functional group and a polymerizable carbon-carbon double bond are alternately referred to herein as “FG-fluoropolymer.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which the claims belong. Although methods and materials similar or equivalent to those described herein can be used in the practice or testing of the embodiments disclosed, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials and processing acts are conventional and may be found in textbooks and other sources within the fluoropolymer art.

### 2. Perfluoromonomer

Perfluoromonomer is defined herein as compounds containing the elements carbon and fluorine and carbon-carbon unsaturation. All monovalent atoms bonded to carbon in the perfluoromonomer are fluorine. In another embodiment, perfluoromonomer further contains heteroatoms selected from the group consisting of oxygen, sulfur and nitrogen.

In another embodiment, perfluoromonomers of utility include perfluoroalkenes and perfluorinated vinyl ethers having 2 to 8 carbon atoms. In another embodiment, perfluorinated vinyl ethers are represented by the formula CF₂═CFOR or CF₂═CFOR′OR, wherein R is perfluorinated linear or branched alkyl groups containing 1 to 5 carbon atoms, and R′ is perfluorinated linear or branched alkylene groups containing 1 to 5 carbon atoms. In another embodiment, R groups contain 1 to 4 carbon atoms. In another embodiment, R′ groups contain 2 to 4 carbon atoms.

Example perfluoromonomers include tetrafluoroethylene (TFE), hexafluoropropylene (HFP), perfluoro-2,2-dimethyl-1,3-dioxole (PDD), perfluoro-2-methylene-4-methyl-1,3-dioxolane (PMD), perfluoro-3,6-dioxa-4-methyl-7-octenesulfonyl fluoride (PSEPVE) and perfluoro(alkyl vinyl ethers) (PAVE) such as perfluoro(methyl vinyl ether) (PMVE), perfluoro(ethyl vinyl ether) (PEVE), perfluoro(propyl vinyl ether) (PPVE), and perfluoro(butyl vinyl ether) (PBVE).

3. Monomer having a Functional Group and a Polymerizable Carbon-Carbon Double Bond (FG)

Monomer having a functional group and a polymerizable carbon-carbon double bond is alternately referred to herein as functional group monomer or FG. The polymerizable carbon-carbon double bond functions to allow repeating units arising from the functional group monomer to be incorporated into the fluoropolymer carbon-carbon chain backbone during the present polymerization process. The functional group functions to increase the adhesion of a fluoropolymer with a given substrate with which it is in contact, for example, to result in strong adhesion between a layer of FG-fluoropolymer and a layer of polyamide. Polyamide and polymer containing fluorine but no FG normally have minimal to no adhesion one to the other.

All monovalent atoms in the functional group monomer are hydrogen, however, the functional group monomer is not further structurally limited. Functional group monomer generally includes compounds having a functional group and a polymerizable carbon-carbon double bond that meet the aforementioned criteria. In another embodiment, functional group monomer comprises the elements carbon, hydrogen and oxygen. In another embodiment, functional group monomer comprises the elements carbon, hydrogen and oxygen further comprises elements selected from the group consisting of nitrogen, phosphorus, sulfur and boron.

Functional groups of utility are not limited, provided that the functional group results in an increase in the adhesion of a fluoropolymer with a given substrate with which it is in contact. Generally, functional groups comprise at least one selected from the group consisting of amine, amide, carboxyl, hydroxyl, phosphonate, sulfonate, nitrile, boronate and epoxide.

In another embodiment, FG contains a carboxyl group (—C(═O)O—) and a polymerizable carbon-carbon double bond. In another embodiment, FG contains a dicarboxylic acid anhydride group (—C(═O)OC(═O)—) and a polymerizable double bond. In another embodiment, FG contains a dicarboxylic acid group capable of forming a cyclic dicarboxylic acid anhydride and a polymerizable carbon-carbon double bond. In another embodiment, FG contains a 1,2- or 1,3-dicarboxylic acid group and a polymerizable carbon-carbon double bond. In another embodiment, FG includes C₄ to C₁₀ dicarboxylic acids and dicarboxylic acid anhydrides containing a polymerizable carbon-carbon double bond. Example FG containing a carboxyl group include: maleic anhydride, maleic acid, fumaric acid, itaconic anhydride, itaconic acid, citraconic anhydride, citraconic acid, mesaconic acid, 5-norbornene-2,3-dicarboxylic anhydride and 5-norbornene-2,3-dicarboxylic acid.

In another embodiment, FG contains an amine group and a polymerizable carbon-carbon double bond. Examples include aminoethyl acrylate, dimethylaminoethyl methacrylate, dimethylaminoethyl acrylate, aminoethyl vinyl ether, dimethylaminoethyl vinyl ether and vinyl aminoacetate.

In another embodiment, FG contains an amide group and a polymerizable carbon-carbon double bond. Examples include N-methyl-N-vinyl acetamide, acrylamide and N-vinylformamide.

In another embodiment, FG contains a hydroxyl group and a polymerizable carbon-carbon double bond. Examples include 2-hydroxyethyl vinyl ether and omega-hydroxybutyl vinyl ether.

In another embodiment, FG contains a phosphonate group and a polymerizable carbon-carbon double bond. An example is diethylvinyl phosphonate.

In another embodiment, FG contains a sulfonate group and a polymerizable carbon-carbon double bond. An example is ammonium vinyl sulfonate.

In another embodiment, FG contains a nitrile group and a polymerizable carbon-carbon double bond. An example is acrylonitrile.

In another embodiment, FG contains a boronate group and a polymerizable carbon-carbon double bond. Examples include vinyl boronic acid dibutyl ester, 4-vinyl phenyl boronic acid and 4-bentenyl boronic acid.

In another embodiment, FG contains an epoxide group and a polymerizable carbon-carbon double bond. An example is allyl glycidyl ether (AGE).

In another embodiment, FG-fluoropolymer produced by the present process comprises about 0.001 to about 25 weight percent repeating units arising from FG. In another embodiment, FG-fluoropolymer produced by the present process comprises about 0.001 to about 20 weight percent repeating units arising from FG. In another embodiment, FG-fluoropolymer produced by the present process comprises about 0.001 to about 15 weight percent repeating units arising from FG. In another embodiment, FG-fluoropolymer produced by the present process comprises about 0.001 to about 10 weight percent of repeating units arising from FG. In another embodiment, FG-fluoropolymer produced by the present process comprises about 0.001 to about 5 weight percent of repeating units arising from FG. In another embodiment, FG-fluoropolymer produced by the present process comprises about 0.001 to about 2 weight percent of repeating units arising from FG. In another embodiment, FG-fluoropolymer produced by the present process comprises about 0.001 to about 1 weight percent of repeating units arising from FG. In another embodiment, FG-fluoropolymer produced by the present process comprises about 0.001 to about 0.5 weight percent of repeating units arising from FG. In another embodiment, FG-fluoropolymer produced by the present process comprises about 0.001 to about 0.3 weight percent of repeating units arising from FG. In another embodiment, FG-fluoropolymer produced by the present process comprises about 0.001 to about 0.1 weight percent of repeating units arising from FG. In another embodiment, FG-fluoropolymer produced by the present process comprises about 0.001 to about 0.01 weight percent of repeating units arising from FG. In another embodiment, FG-fluoropolymer produced by the present process comprises about 0.01 to about 2 weight percent of repeating units arising from FG. In another embodiment, FG-fluoropolymer produced by the present process comprises about 0.01 to about 1 weight percent of repeating units arising from FG. In another embodiment, FG-fluoropolymer produced by the present process comprises about 0.01 to about 0.5 weight percent of repeating units arising from FG. In another embodiment, FG-fluoropolymer produced by the present process comprises about 0.03 to about 0.3 weight percent of repeating units arising from FG. The weight percent of repeating units arising from FG referred to here is relative to the sum of the weight of repeating units arising from FG and perfluoromonomer in the FG-fluoropolymer.

### 4. FG-Fluoropolymer Melting Point and Melt Flow Rate

FG-fluoropolymer melting point can be determined by ASTM method D 4591-01, “Standard Test Method for Determining Temperatures and Heats of Transitions of Fluoropolymers by Differential Scanning Calorimetry.”

In an embodiment the melting point of the FG-fluoropolymer produced by the present process is below about 265° C. In another embodiment the melting point of the FG-fluoropolymer produced by the present process is below about 260° C. In another embodiment the melting point of the FG-fluoropolymer produced by the present process is below about 250° C. In another embodiment the melting point of the FG-fluoropolymer produced by the present process is below about 240° C. In another embodiment the melting point of the FG-fluoropolymer produced by the present process is below about 230° C. In another embodiment the melting point of the FG-fluoropolymer produced by the present process is below about 220° C.

FG-fluoropolymer melt flow rate (MFR) can be determined by ASTM method D1238-04c. The present process has the capability of producing an FG-fluoropolymer of a desired MFR for a specific utility, e.g., an FG-fluoropolymer MFR substantially similar to the MFR of another polymer that the FG-fluoropolymer is to be coextruded with.

In another embodiment, MFR of FG-fluoropolymer produced by the present process is about 1 to about 400 g/10 minute. In another embodiment, MFR of FG-fluoropolymer produced by the present process is about 10 to about 300 g/10 minute. In another embodiment, MFR of FG-fluoropolymer produced by the present process is about 1 to about 100 g/10 minute. In another embodiment, MFR of FG-fluoropolymer produced by the present process is about 20 to about 90 g/10 minute. In another embodiment, MFR of FG-fluoropolymer produced by the present process is about 1 to about 50 g/10 minute. In another embodiment, MFR of FG-fluoropolymer produced by the present process is about 5 to about 40 g/10 minute. In another embodiment, MFR of FG-fluoropolymer produced by the present process is about 10 to about 30 g/10 minute. In another embodiment, MFR of FG-fluoropolymer produced by the present process is about 15 to about 30 g/10 minute. In another embodiment, MFR of FG-fluoropolymer produced by the present process is about 20 to about 30 g/10 minute.

### 5. Combining Water and a Perfluoromonomer to Form a Reaction Mixture (A)

The present process involves (A) combining water and a perfluoromonomer to form a reaction mixture.

5.1 Surfactant

In an embodiment, surfactant is further added to the reaction mixture and the reaction mixture comprises an aqueous dispersion. Surfactants generally suitable for use in dispersion polymerization of tetrafluoroethylene copolymers are of utility in the present process. Such surfactants include, for example, ammonium perfluorooctanoate, ammonium perfluorononanoate, and perfluoroalkyl ethane sulfonic acids and salts thereof.

5.2 Chain Transfer Agent (CTA)

In an embodiment, CTA is further added to the reaction mixture. A wide range of compounds can be used as CTA. Such compounds include, for example, hydrogen-containing compounds such as molecular hydrogen, the lower alkanes, and lower alkanes substituted with halogen atoms. The chain transfer activity of such compounds when used in the present process can result in FG-fluoropolymer having —CF₂H end groups. The CTA can contribute other end groups, depending on the identity of the CTA. Example CTAs include methane, ethane, and substituted hydrocarbons such as methyl chloride, methylene chloride, chloroform, and carbon tetrachloride. The amount of CTA used to achieve desired molecular weight will depend, for given polymerization conditions, on the amount of initiator used and on the chain transfer efficiency of the chosen CTA. Chain transfer efficiency can vary substantially from compound to compound, and varies with temperature. The amount of CTA needed to obtain a desired polymerization result can be determined by one of ordinary skill in this field without undue experimentation

### 6. Initiating Polymerization of the Perfluoromonomer (B)

The present process involves (B) initiating polymerization of the perfluoromonomer.

Following (A), in which water and a perfluoromonomer, as well as optional components (e.g., surfactant, CTA) are combined to form a reaction mixture, the reaction mixture is optionally heated to a chosen temperature, and then agitation is started, and initiator is then added at a desired rate to initiate polymerization of the perfluoromonomer.

Perfluoromonomer addition is started and controlled according to the scheme chosen to regulate the polymerization. An initiator, which can be the same as or different from the first initiator used, is usually added throughout the reaction.

6.1 Initiator

Initiators of utility in the present process are those commonly employed in emulsion (dispersion) polymerization of tetrafluoroethylene copolymers. For example, water-soluble free-radical initiators such as ammonium persulfate (APS), potassium persulfate (KPS), or disuccinic acid peroxide, or redox systems such as those based on potassium permanganate. The amount of initiator used depends on the amount of chain-transfer agent (CTA) used. For APS and KPS for which initiation efficiency approaches 100% at high temperature (e.g. 100° C.), the amount of initiator, relative to the amount of FG-fluoropolymer formed, is generally less than 0.5 mol/mol, desirably no more than 0.35 mol/mol, and preferably no more than 0.2 mol/mol. When the initiator has lower initiation efficiency, such as APS or KPS at lower temperature, these initiator amounts refer to the proportion of polymer molecules initiated (made) by the initiator. Both situations can be described in terms of effective initiator amount per mole of polymer made.

6.2 Temperature

In the embodiment where the present aqueous polymerization process comprises aqueous dispersion polymerization, a broad range of temperatures are of utility. Because of heat transfer considerations and the use of thermally activated initiators, higher temperatures are advantageous, such as temperatures in the range of about 50-100° C. In another embodiment, temperature in the range 70-90° C. is used. Surfactants used in emulsion polymerization appear to be less effective at temperatures above 103-108° C. as there is a tendency to lose dispersion stability.

6.3 Pressure

Any workable pressure can be used in the present polymerization process. High pressure offers an advantage over low pressure in increased reaction rate. However, the polymerization of TFE is highly exothermic, so high reaction rate increases the heat that must be removed or accommodated as temperature increases. Pressures that can be used are also determined by equipment design and by safety concerns in the handling of TFE. In an embodiment, pressures in the range of about 0.3-7 MPa are used. In another embodiment, pressures in the range 0.7-3.5 MPa are used. While it is common to maintain constant pressure in the reactor, in another embodiment, pressure can be varied.

### 7. Polymerizing a Portion of the Perfluoromonomer to Form Particles of Polymerized Perfluoromonomer (C)

The present process involves a step of (C) polymerizing a portion of the perfluoromonomer to form particles of polymerized perfluoromonomer in the reaction mixture. In (C), polymerizing a portion of the perfluoromonomer means an amount of perfluoromonomer less than the total amount combined with water in (A) to form the reaction mixture.

In an embodiment, to determine that a portion of the perfluoromonomer has polymerized and formed particles of polymerized perfluoromonomer in the reaction mixture, the total pressure within the vessel containing the reaction mixture is monitored. A perfluoromonomer pressure drop following initiation (B) indicates that polymerization of perfluoromonomer has begun and particles of polymerized perfluoromonomer have been formed. In another embodiment, the pressure drop is at least about 35 Kappa (5 psi). In another embodiment, the pressure drop is at least about 70 Kappa (10 psi). In another embodiment, proof that polymerization of a portion of the perfluoromonomer has been achieved is that the reactor continues to consume perfluoromonomer, observed for example by the activation of a perfluoromonomer feed valve attached by a feedback control loop.

In another embodiment, the pressure drop represents about a 0.1 weight percent solids polymerized fluoromonomer based on the water phase of the reaction mixture. Below such a solids level it is uncertain whether the polymerization has established itself enough to avoid being quenched by (D) addition to the reaction mixture a hydrocarbon monomer having a functional group and a polymerizable carbon-carbon double bond. In another embodiment, (C) polymerizing a portion of the perfluoromonomer to form particles of polymerized perfluoromonomer is carried out until about 1 weight percent solids polymer has been formed based on the water phase of the reaction mixture. This represents a small portion of the final fluoropolymer batch size, typically less than about 5 percent of the total fluoropolymer to be made. Waiting until higher levels of polymer has been formed in (C) does not give additional benefit to establishing the polymerization, and might begin to make the reaction mixture unnecessarily nonhomogeneous.

In a suspension or “granular” TFE type polymerization embodiment, the about 0.1 to about 2 weight percent solids polymerized perfluoromonomer is in the form of small irregular spongy polymer particles of indeterminate size and shape, non-water wetted, and floating on the surface of the reaction mixture where they are available for direct polymer-vapor space polymerization. As the polymerization proceeds, more polymer particles are formed and the ones already in existence become larger. The size and shape of the polymer particles depend on the details of the polymerization. In another embodiment, suspension polymerization particles formed early in the batch have the size and shape of popped popcorn that has been rolled and crushed by hand. In another embodiment, suspension polymerization particles formed early in the batch have the size and shape of shredded coconut from the grocery store. In another embodiment, suspension polymerization particles formed early in the batch have the appearance and texture of powdered sugar.

In a dispersion polymerization embodiment, wherein surfactant is further added to the reaction mixture and the reaction mixture comprises a colloidally stable aqueous dispersion, the about 0.1 to about 2 weight percent polymerized perfluoromonomer is in the form of the initial particles made sometime during initiation of polymerization. After perfluoromonomer pressure drop following initiation, the presence of the colloidally stable particles inhibits formation of more particles by sweeping the aqueous reaction mixture phase of colloidally unstable precursor particles before the precursors have a chance to grow large enough to become colloidally stable themselves.

In another embodiment of this step of (C) polymerizing a portion of the perfluoromonomer to form particles of polymerized perfluoromonomer, there are about 10¹² particles of polymerized perfluoromonomer per gram of water in the reaction mixture. Fewer particles than that and the particles can undesirably become too big at too low a percent solids to be colloidally stable, resulting in coagulum problems. The value of 10¹² particles per gram of water in the reaction mixture is calculated for a polymerization with RDPS of 400 nm at 10% solids as a lower limit of industrial practicality. In another embodiment, particles have an RDPS of 300 nm or less at 20% solids or greater.

7.1 Regulating the Rate of Polyermization

There are several alternatives for regulating the rate of polymerization. It is common with most alternatives first to precharge at least part of the perfluoromonomer(s) other than TFE (e.g., HFP, PAVE) (herein also referred to as “modifier”), and then to add TFE to the desired total pressure. Additional TFE is then added after initiation and polymerization kickoff to maintain a chosen pressure, and additional modifier may be added, also. The TFE may be added at a constant rate, with agitator speed changed as necessary to increase or decrease actual polymerization rate and thus to maintain constant total pressure. In a variant of this alternative, pressure may be varied to maintain constant reaction rate at constant TFE feed rate and constant agitator speed. Alternatively, the total pressure and the agitator speed may both be held constant, with TFE added as necessary to maintain the constant pressure. A third alternative is to carry out the polymerization in stages with variable agitator speed, but with steadily increasing TFE feed rates. When modifier is added during the reaction, it is convenient to inject modifier at a fixed rate. In another embodiment, the rate of modifier addition is uniform during a given phase of polymerization. However, one skilled in the art will appreciate that a wide variety of modifier addition programs can be employed. Thus, for example, a series of discrete modifier additions can be used. Such discrete additions can be in equal or varying amounts, and at equal or varying intervals. Other non-uniform programs for addition of modifier can be used.

8. Adding to the Reaction Mixture a Monomer having a Functional Group and a Polymerizable Carbon-Carbon Double Bond (D)

The total pressure above the reaction mixture is monitored. A pressure drop of at least about 35 KPa (5 psi), generally at least about 70 KPa (10 psi), occurring after initiation indicates that polymerization of perfluoromonomer has begun and particles of polymerized perfluoromonomer are being formed.

Following the pressure drop indicating that polymerization of perfluoromonomer has begun and particles of polymerized perfluoromonomer have formed, monomer having a functional group and a polymerizable carbon-carbon double bond (functional group monomer, or FG) is added to the reaction mixture. In another embodiment, FG is added to the reaction mixture in one aliquot. In another embodiment, FG is added to the reaction mixture continuously or periodically over the total period of polymerization.

The addition of FG to the polymerization aqueous reaction mixture following the pressure drop indicating that polymerization of perfluoromonomer has begun and particles of polymerized perfluoromonomer are being formed, has been discovered to lead to productive and controllable incorporation in the fluoropolymer carbon-carbon backbone of repeating units arising from FG.

Precharging FG to the polymerization aqueous reaction mixture has been discovered to not lead to productive incorporation in the fluoropolymer carbon-carbon backbone of repeating units arising from FG.

### 9. pH of the Reaction Mixture

In another embodiment of the present process, FG contains a carboxyl group capable of forming a carboxylic acid and/or a carboxylic acid anhydride, and the pH of the reaction mixture measured at 25° C. is less than or equal to the pKₐ of the carboxylic acid of the FG during (C) polymerization of the perfluoromonomer to form particles of polymerized perfluoromonomer and (D) the addition of FG to the reaction mixture.

In another embodiment of the present process, FG contains a cyclic dicarboxylic acid anhydride and/or a dicarboxylic acid capable of forming a cyclic dicarboxylic acid anhydride, and the pH of the reaction mixture measured at 25° C. is less than or equal to the pKₐ₁ of the dicarboxylic acid of the FG during (C) polymerization of the perfluoromonomer to form particles of polymerized perfluoromonomer and (D) the addition of FG to the reaction mixture.

Controlling the pH of the aqueous polymerization process reaction mixture has been discovered to lead to productive incorporation in the fluoropolymer carbon-carbon backbone of repeating units arising from FG. Without wishing to be bound by theory, it is believed that so controlling the pH of the aqueous polymerization process reaction mixture results in a sufficient concentration of FG being present in the phase of the reaction mixture containing reactive fluoropolymer chain radicals.

In another embodiment of the present process, the reaction mixture further comprises a strong acid for the purpose of controlling the pH of the reaction mixture measured at 25° C. at less than or equal to the pKₐ of the carboxylic acid of the FG during (C) polymerization of the perfluoromonomer to form particles of polymerized perfluoromonomer and (D) the addition of FG to the reaction mixture. Strong acids of utility include any that will not impede the polymerization process, including inorganic or mineral acids (e.g., nitric acid) and organic acids (e.g., oxalic acid). In another embodiment, strong acid comprises those acids with a pKₐ of about 1 or less.

In another embodiment of the present process, the reaction mixture further comprises an acidic buffer for the purpose of controlling the pH of the reaction mixture measured at 25° C. at less than or equal to the pKₐ of the carboxylic acid of the FG during (C) polymerization of the perfluoromonomer to form particles of polymerized perfluoromonomer and (D) the addition of FG to the reaction mixture. Acidic buffers of utility include any that will not impede the polymerization process, for example, phosphate buffer.

For the purpose of these comparisons of reaction mixture pH with pKₐ (or pKₐ₁) of the carboxylic acid, pH is measured at 25° C.

### 10. FG-Fluoropolymer Produced by the Present Process

In another embodiment, FG-fluoropolymer produced by the present process comprises repeating units arising from perfluoromonomer and FG and is perfluorinated except for repeating units arising from FG.

10.1 FG-Fluoropolymer Comprising TFE, HFP and FG

In another embodiment the FG-fluoropolymer comprising TFE, HFP and FG produced by the present process comprises: (a) about 2 to about 20 weight percent repeating units arising from HFP; (b) about 0.001 to about 25 weight percent repeating units arising from FG; and (c) the remaining weight percent repeating units arising from TFE.

In another embodiment, the FG-fluoropolymer comprising TFE, HFP and FG produced by the present process comprises about 4 to about 20 weight percent repeating units arising from HFP. In another embodiment, the FG-fluoropolymer comprising TFE, HFP and FG produced by the present process comprises about 4 to about 14 weight percent repeating units arising from HFP. In another embodiment, the FG-fluoropolymer comprising TFE, HFP and FG produced by the present process comprises about 4 to about 14 weight percent repeating units arising from HFP. In another embodiment, the FG-fluoropolymer comprising TFE, HFP and FG produced by the present process comprises about 10 to about 12 weight percent repeating units arising from HFP.

Various embodiments of the amount of repeating units arising from FG in the FG-fluoropolymer comprising TFE, HFP and FG are contemplated, and are described earlier herein at section titled “3. Monomer Having A Functional Group and a Polymerizable Carbon-Carbon Double Bond (FG)”.

FG-Fluoropolymer Comprising TFE, PAVE and FG

In another embodiment, FG-fluoropolymer produced by the present process comprises: (a) about 2 to about 20 weight percent repeating units arising from PAVE; (b) about 0.001 to about 25 weight percent repeating units arising from FG; and (c) the remaining weight percent repeating units arising from TFE.

In another embodiment, the FG-fluoropolymer comprising TFE, PAVE and FG produced by the present process comprises about 2 to about 18 weight percent repeating units arising from PAVE. In another embodiment, the FG-fluoropolymer comprising TFE, PAVE and FG produced by the present process comprises about 3 to about 18 weight percent repeating units arising from PAVE. In another embodiment, the FG-fluoropolymer comprising TFE, PAVE and FG produced by the present process comprises about 7 to about 18 weight percent repeating units arising from PAVE. In another embodiment, the FG-fluoropolymer comprising TFE, PAVE and FG produced by the present process comprises about 9 to about 15 weight percent repeating units arising from PAVE.

Various embodiments of the amount of repeating units arising from FG in the FG-fluoropolymer comprising TFE, PAVE and FG are contemplated, and are described earlier herein in the section titled “3. Monomer Having a Functional Group and a Polymerizable Carbon-Carbon Double Bond (FG).”

FG-Fluoropolymer Comprising TFE, HFP, PAVE and FG

In another embodiment, the FG-fluoropolymer comprises repeating units arising from TFE, HFP, perfluoro(alkyl vinyl ether) (PAVE) and FG.

In another embodiment, the FG-fluoropolymer comprising TFE, HFP, PAVE and FG produced by the present process comprises: (a) about 2 to about 20 weight percent of repeating units arising from HFP; (b) about 0.001 to about 10 weight percent of repeating units arising from FG; (c) about 2 to about 10 weight percent of repeating units arising from PAVE; and (d) the remaining weight percent of the repeating units arising from TFE; wherein the sum of the weight percent of repeating units arising from HFP and PAVE is greater than about 4 weight percent and less than about 20 weight percent.

In another embodiment, the FG-fluoropolymer comprising TFE, HFP, PAVE and FG produced by the present process comprises about 4 to about 20 weight percent repeating units arising from HFP. In another embodiment, the FG-fluoropolymer comprising TFE, HFP, PAVE and FG produced by the present process comprises about 4 to about 16 weight percent repeating units arising from HFP. In another embodiment, the FG-fluoropolymer comprising TFE, HFP, PAVE and FG produced by the present process comprises about 8 to about 16 weight percent repeating units arising from HFP. In another embodiment, the FG-fluoropolymer comprising TFE, HFP, PAVE and FG produced by the present process comprises about 9 to about 14 weight percent repeating units arising from HFP.

In another embodiment, the FG-fluoropolymer comprising TFE, HFP, PAVE and FG produced by the present process comprises about 1 to about 10 weight percent repeating units arising from PAVE. In another embodiment, the FG-fluoropolymer comprising TFE, HFP, PAVE and FG produced by the present process comprises about 2 to about 8 weight percent repeating units arising from PAVE. In another embodiment, the FG-fluoropolymer comprising TFE, HFP, PAVE and FG produced by the present process comprises about 3 to about 7 weight percent repeating units arising from PAVE.

Various embodiments of the amount of repeating units arising from FG in the TFE/HFP/PAVE/FG melt processible semicrystalline fluoropolymer are contemplated, and are described earlier herein at section titled “3. Monomer Having A Functional Group and a Polymerizable Carbon-Carbon Double Bond (FG)”.

In another embodiment, the FG-fluoropolymer comprising TFE, HFP, PAVE and FG produced by the present process comprises: (a) about 12 weight percent of repeating units arising from HFP; (b) about 0.01 to about 0.1 weight percent of repeating units arising from FG; (c) and about 0.75 weight percent of repeating units arising from PAVE; and (d) the remaining weight percent repeating units arising from TFE.

In another embodiment, the FG-fluoropolymer comprising TFE, HFP, PAVE and FG produced by the present process comprises: (a) about 12 weight percent of repeating units arising from HFP; (b) about 0.01 to about 0.1 weight percent of repeating units arising from FG; (c) and about 1.5 weight percent of repeating units arising from PAVE; and (d) the remaining weight percent repeating units arising from TFE.

In another embodiment, the FG-fluoropolymer comprising TFE, HFP, PAVE and FG produced by the present process comprises: (a) about 6 weight percent of repeating units arising from HFP; (b) about 0.01 to about 0.1 weight percent of repeating units arising from FG; (c) and about 2 weight percent of repeating units arising from PAVE; and (d) the remaining weight percent repeating units arising from TFE.

In another embodiment, the FG-fluoropolymer comprising TFE, HFP, PAVE and FG produced by the present process comprises: (a) about 5 weight percent of repeating units arising from HFP; (b) about 0.01 to about 0.1 weight percent of repeating units arising from FG; (c) and about 5 weight percent of repeating units arising from PAVE; and (d) the remaining weight percent repeating units arising from TFE.

In another embodiment, the FG-fluoropolymer comprising TFE, HFP, PAVE and FG produced by the present process comprises: (a) about 5 to about 6 weight percent of repeating units arising from HFP; (b) about 0.01 to about 0.1 weight percent of repeating units arising from FG; (c) about 6 to about 7 weight percent of repeating units arising from perfluoro(methyl vinyl ether); and (d) about 86 to about 89 weight percent of repeating units arising from TFE.

### 11. Optional Monomers

In another embodiment, FG-fluoropolymer produced by the present process optionally contains repeating units arising from a non-perfluorinated monomer such as ethylene, propylene, vinylidene fluoride and vinyl fluoride. If repeating units arising from such non-perfluorinated monomers are included in the FG-fluoropolymer, they are present at a low level that does not affect the desirable properties of the FG-fluoropolymer.

In another embodiment, the FG-fluoropolymer contains about 0.1 to about 5 weight percent of repeating units arising from non-perfluorinated monomers other than FG. In another embodiment, the FG-fluoropolymer contains about 2 weight percent or less of repeating units arising from non-perfluorinated monomers other than FG. In another embodiment, the FG-fluoropolymer contains about 1 weight percent or less of repeating units arising from non-perfluorinated monomers other than FG.

### 12. Utility of FG-Fluoropolymer Produced by the Present Process

FG-fluoropolymer produced by the present process has utility as adhesive for adhering perfluoropolymer (e.g., PTFE, FEP, PFA) and polymer, metal or inorganic substrates. Perfluoropolymer strongly adheres to FG-fluoropolymer, and FG-fluoropolymer strongly adheres to many polymers, metals and inorganics.

In another embodiment, FG-fluoropolymer can be used to adhere perfluoropolymer and thermoplastic having amine functionality in a multilayer article such as a perfluoropolymer-lined polyamide tube of utility for petroleum fuel service. In order to form such an article, a layer of FG-fluoropolymer can be melt extruded as an interlayer between a melt extruded layer of perfluoropolymer and a melt extruded layer of polyamide.

In another embodiment, a substrate contains functional groups (e.g., amine) that react or otherwise strongly associate with functional groups of an FG-fluoropolymer, resulting in a strong adhesion between the FG-fluoropolymer and such a substrate.

In another embodiment, blends of FG-fluoropolymer and other polymers can be made during polymer synthesis. In another embodiment, FG-fluoropolymer can be blended, or melt blended, with another polymer, and the resultant blend used as adhesive.

In another embodiment FG-fluoropolymer is coextruded as an adhesive layer between two other polymer layers to be adhered.

The use of FG-fluoropolymer as adhesive can be accomplished as is known in the art for other kinds of polymers which accomplish the same end using similar methods. For instance, melt mixing of polymers using equipment such as screw extruders is known. Similarly multilayer film extrusion, including the use of adhesive or tie layers is also known.

### EXAMPLES

The concepts described herein will be further described in the following examples, which do not limit the scope of the invention described in the claims.

### METHODS

MFR: Melt flow rate (MFR) is measured by ASTM method D1238-04c, modified as follows: The cylinder, orifice and piston tip are made of a corrosion-resistant alloy, Haynes Stellite 19, made by Haynes Stellite Co. The 5.0 g sample is charged to the 9.53 mm (0.375 inch) inside diameter cylinder, which is maintained at 372±1° C. Five minutes after the sample is charged to the cylinder, it is extruded through a 2.10 mm (0.0825 inch) diameter, 8.00 mm (0.315 inch) long square-edge orifice under a load (piston plus weight) of 5000 grams.

### Example 1

### FG-Fluoropolymer Comprising TFE, HFP, PEVE and Itaconic Acid

A cylindrical, horizontal, water-jacketed, paddle-stirred, stainless steel reactor having a length to diameter ratio of about 1.5 and a water capacity of 10 gallons (37.9 L) was charged with 50 pounds (22.7 kg) of demineralized water, 330 mL of a 20 wt % solution of ammonium perfluorooctanoate surfactant in water, and 5 grams of Krytox® 157 FSL perfluoropolymer carboxylic acid. With the reactor paddle agitated at 46 rpm, the reactor was heated to 60° C., evacuated and purged three times with TFE. The reactor temperature then was increased to 103° C. After the temperature had become steady at 103° C., HFP was added slowly to the reactor until the pressure was 444 psig (3.16 MPa). Ninety-two mL of liquid PEVE was injected into the reactor. Then TFE was added to the reactor to achieve a final pressure of 645 psig (4.55 MPa). Then 40 mL of freshly prepared aqueous initiator solution containing 1.63 wt % ammonium persulfate (APS) was charged into the reactor. Then, this same initiator solution was pumped into the reactor at 10 mL/min for the remainder of the polymerization. After polymerization had begun as indicated by a 10 psi (70 KPa) drop in reactor pressure, additional TFE was added to the reactor at a rate of 24.5 pound (11.1 kg)/125 minutes. Furthermore, liquid PEVE was added at a rate of 1.0 mL/min for the duration of the reaction. After 1 pound (0.45 kg) of TFE had been fed after kickoff, an aqueous solution of 1 wt % itaconic acid was started at 5 mL/minute and continued for the remainder of the batch. After 24.4 pounds (11.1 kg) of TFE had been injected over a reaction period of 125 minutes, the reaction was terminated. At the end of the reaction period, the TFE feed, PEVE feed, and the initiator feed were stopped, and the reactor was cooled while maintaining agitation. When the temperature of the reactor contents reached 90° C., the reactor was slowly vented. After venting to nearly atmospheric pressure, the reactor was purged with nitrogen to remove residual monomer. Upon further cooling, the dispersion was discharged from the reactor at below 70° C. After coagulation, the polymer was isolated by filtering and then drying in a 150° C. convection air oven. The polymer had a melt flow rate of 34.7 g/10 min, a melting point of 234° C. and HFP content of 13.90 wt %, a PEVE content of 1.69 wt %, and an itaconic acid content of 0.05 wt %.

Four FG-fluoropolymer samples were prepared by the above procedure, except that the injection rate of itaconic acid (ITA) was varied from sample to sample to achieve a different weight percent ITA as shown in Table 1.

TABLE 1

| | WT % | WT % | | WT % | MELTING |
|---|---|---|---|---|---|
| EXAMPLE | HFP | PEVE | MFR | ITA | POINT |
| 1-A | 13.90 | 1.69 | 34.7 | 0.05 | 234 |
| 1-B | 14.94 | 1.75 | 64.5 | 0.02 | 225 |
| 1-C | 15.87 | 1.73 | 62.5 | 0.01 | 219 |
| 1-D | 15.96 | 1.73 | 68.7 | 0.005 | 218 |

### Example 2

### FG-Fluoropolymer: TFE/HFP/PEVE/Mesaconic Acid

A cylindrical, horizontal, water-jacketed, paddle-stirred, stainless steel reactor having a length to diameter ratio of about 1.5 and a water capacity of 10 gallons (37.9 L) was charged with 50 pounds (22.7 kg) of demineralized water, 500 mL of 0.1 N nitric acid, 260 mL of a 20 wt % solution of ammonium perfluorooctanoate surfactant in water, and 2 grams of Krytox®157 FSL perfluoropolymer carboxylic acid. With the reactor paddle agitated at 46 rpm, the reactor was heated to 60° C., evacuated and purged three times with TFE. The reactor temperature then was increased to 103° C. After the temperature had become steady at 103° C., HFP was added slowly to the reactor until the pressure was 444 psig (3.16 MPa). Ninety-two mL of liquid PEVE was injected into the reactor. Then TFE was added to the reactor to achieve a final pressure of 645 psig (4.55 MPa). Then 50 mL of freshly prepared aqueous initiator solution containing 2.38 wt % ammonium persulfate (APS) was charged into the reactor. Then, this same initiator solution was pumped into the reactor at 10 mL/min for the remainder of the polymerization. After polymerization had begun as indicated by a 10 psi (70 KPa) drop in reactor pressure, additional TFE was added to the reactor at a rate of 15 pound (6.8 kg)/125 minutes. Furthermore, liquid PEVE was added at a rate of 1.0 mL/min for the duration of the reaction. After 1 pound (0.45 kg) of TFE had been fed after kickoff, an aqueous solution of 1 wt % mesaconic acid was started at 5 mL/minute and continued for the remainder of the batch. After 15 pounds (6.8 kg) of TFE had been injected over a reaction period of 125 minutes, the reaction was terminated. At the end of the reaction period, the TFE, PEVE, initiator solution and mesaconic acid solution feeds were stopped, and the reactor was cooled while maintaining agitation. When the temperature of the reactor contents reached 90° C., the reactor was slowly vented. After venting to nearly atmospheric pressure, the reactor was purged with nitrogen to remove residual monomer. Upon further cooling, the dispersion was discharged from the reactor at below 70° C. After coagulation, the polymer was isolated by filtering and then drying in a 150° C. convection air oven. The polymer had a melt flow rate of 79.6 g/10 min, a melting point of 224° C., an HFP content of 16.5 wt %, a PEVE content of 1.19 wt %, and a mesaconic acid content of 0.031 wt %.

Five FG-fluoropolymer samples were prepared by the above procedure, except that the feed rate of TFE was varied from about 36 to about 76 g/min by adjusting the TFE pressure to achieve the results shown in Table 2.

TABLE 2

| | TFE | | | | Melting | |
|---|---|---|---|---|---|---|
| | Rate | WT % | WT % | | Point | WT % |
| EXAMPLE | (g/min) | HFP | PEVE | MFR | (° C.) | MSA |
| 2-A | 36.3 | 16.5 | 1.19 | 79.6 | 224 | 0.031 |
| 2-B | 54.4 | 12.6 | 1.20 | 138 | 263 | 0.032 |
| 2-C | 52.3 | 14.5 | 0.92 | 216 | 243 | 0.032 |
| 2-D | 64.8 | 12.5 | 0.60 | 97.8 | 257 | 0.033 |
| 2-E | 76.2 | 12.8 | 0.95 | 88.2 | 234 | 0.032 |

### Example 3

### FG-Fluoropolymer: TFE/PEVE/Itaconic Acid

A cylindrical, horizontal, water-jacketed, paddle-stirred, stainless steel reactor having a length to diameter ratio of about 1.5 and a water capacity of 10 gallons (37.9 L) was charged with 50 pounds (22.7 kg) of demineralized water, 260 mL of a 20 wt % solution of ammonium perfluorooctanoate surfactant in water, and 2 grams of Krytox® 157 FSL perfluoropolymer carboxylic acid. With the reactor paddle agitated at 50 rpm, the reactor was heated to 25° C., evacuated and purged three times with tetrafluoroethylene (TFE). The reactor was then charged with ethane to 8 inches Hg (27 KPa). The reactor temperature then was increased to 75° C. Then 400 mL of liquid PEVE was injected into the reactor. Then TFE was added to the reactor to achieve a final pressure of 300 psig (2.17 MPa). Then 400 mL of freshly prepared aqueous initiator solution containing 1.83 wt % ammonium persulfate (APS) was charged into the reactor. Then, this same initiator solution was pumped into the reactor at 2 mL/min for the remainder of the polymerization. After polymerization had begun as indicated by a 10 psi (70 KPa) drop in reactor pressure, additional TFE was added to the reactor at a rate of 20 pounds (9.1 kg)/120 minutes. Furthermore, liquid PEVE was added at a rate of 5.0 mL/min for the duration of the reaction. After 1 pound (0.45 kg) of TFE had been fed after kickoff, an aqueous solution of 1 wt % itaconic acid was started at 5 mL/minute and continued for the remainder of the batch. After 20 pounds (9.1 kg) of TFE had been injected over a reaction period of 120 minutes, the reaction was terminated. At the end of the reaction period, the TFE, PEVE, initiator solution and itaconic acid solution feeds were stopped, and the reactor was slowly vented. After venting to nearly atmospheric pressure, the reactor was purged with nitrogen to remove residual monomer. Upon further cooling, the dispersion was discharged from the reactor at below 60° C. After coagulation, the polymer was isolated by filtering and then drying in a 150° C. convection air oven. The polymer had a melt flow rate of 42.0 g/10 min, a melting point of 257° C., a PEVE content of 9.0 wt %, and an itaconic acid content of 0.076 wt %.

### Example 4

### FG-Fluoropolymer: TFE/PEVE/Allyl Glycidyl Ether

A cylindrical, horizontal, water-jacketed, paddle-stirred, stainless steel reactor having a length to diameter ratio of about 1.5 and a water capacity of 10 gallons (37.9 L) was charged with 50 pounds (22.7 kg) of demineralized water, 15.4 grams dibasic ammonium phosphate, 17.5 grams monobasic ammonium phosphate, 580 mL of a 20 wt % solution of ammonium perfluoro-2-propoxypropionate surfactant in water, and 4.5 grams of Krytox® 157 FSL perfluoropolymer carboxylic acid. With the reactor paddle agitated at 50 rpm, the reactor was heated to 25° C., evacuated and purged three times with tetrafluoroethylene (TFE). The reactor was then charged with ethane to 8 inches Hg (27 KPa). The reactor temperature then was increased to 75° C. Then 400 mL of liquid PEVE was injected into the reactor. Then TFE was added to the reactor to achieve a final pressure of 200 psig (1.48 MPa). Then 400 mL of freshly prepared aqueous initiator solution containing 1.83 wt % ammonium persulfate (APS) was charged into the reactor. Then, this same initiator solution was pumped into the reactor at 2 mL/min for the remainder of the polymerization. After polymerization had begun as indicated by a 10 psi (70 KPa) drop in reactor pressure, additional TFE was added to the reactor at a rate of 12 pounds (5.4 kg)/120 minutes. Furthermore, liquid PEVE was added at a rate of 5.0 mL/min for the duration of the reaction. After 1 pound (0.45 kg) of TFE had been fed after kickoff, an aqueous solution of 1 wt % allyl glycidyl ether was started at 5 mL/minute and continued for the remainder of the batch. After 12 pounds (5.4 kg) of TFE had been injected over a reaction period of 120 minutes, the reaction was terminated. At the end of the reaction period, the TFE, PEVE, initiator solution and allyl glycidyl ether solution feeds were stopped, and the reactor was slowly vented. After venting to nearly atmospheric pressure, the reactor was purged with nitrogen to remove residual monomer. Upon further cooling, the dispersion was discharged from the reactor at below 60° C. After coagulation, the polymer was isolated by filtering and then drying in a 150° C. convection air oven. The polymer had a melt flow rate of 12.2 g/10 min, a melting point of 244° C., a PEVE content of 15.1 wt %, and an allyl glycidyl ether content of 0.088 wt %.

### Example 5

### FG-Fluoropolymer: TFE/HFP/PEVE/Hydroxybutyl Vinyl Ether

A cylindrical, horizontal, water-jacketed, paddle-stirred, stainless steel reactor having a length to diameter ratio of about 1.5 and a water capacity of 10 gallons (37.9 L) was charged with 50 pounds (22.7 kg) of demineralized water, 330 mL of a 20 wt % solution of ammonium perfluorooctanoate surfactant in water, and 5.9 grams of Krytox® 157 FSL perfluoropolymer carboxylic acid. With the reactor paddle agitated at 46 rpm, the reactor was heated to 60° C., evacuated and purged three times with tetrafluoroethylene (TFE). The reactor temperature then was increased to 103° C. After the temperature had become steady at 103° C., HFP was added slowly to the reactor until the pressure was 444 psig (3.16 MPa). Then 92 mL of liquid PEVE was injected into the reactor. Then TFE was added to the reactor to achieve a final pressure of 645 psig (4.55 MPa). Then 40 mL of freshly prepared aqueous initiator solution containing 1.83 wt % ammonium persulfate (APS) was charged into the reactor. Then, this same initiator solution was pumped into the reactor at 10 mL/min for the remainder of the polymerization. After polymerization had begun as indicated by a 10 psi (70 KPa) drop in reactor pressure, additional TFE was added to the reactor at a rate of 24.5 pounds (11.1 kg)/125 minutes. Furthermore, liquid PEVE was added at a rate of 1.0 mL/min for the duration of the reaction. After 1 pound (0.45 kg) of TFE had been fed after kickoff, hydroxybutyl vinyl ether (HBVE, density 0.939 g/mL) was injected at a rate of 0.05 mL/min for 110 minutes. At this point, approximately 10 minutes before the end of the batch, the PEVE feed was also stopped. After 24.5 pounds (11.1 kg) of TFE had been injected over a reaction period of 125 minutes, the reaction was terminated. At the end of the reaction period, the TFE and initiator solution feeds were stopped, and the reactor was cooled while maintaining agitation. When the temperature of the reactor contents reached 90° C., the reactor was slowly vented. After venting to nearly atmospheric pressure, the reactor was purged with nitrogen to remove residual monomer. Upon further cooling, the dispersion was discharged from the reactor at below 70° C. After coagulation, the polymer was isolated by filtering and then drying in a 150° C. convection air oven. The polymer had a melt flow rate of 100 g/10 min, a melting point of 228° C., an HFP content of 13.57 wt %, a PEVE content of 1.36 wt %, and an HBVE content of 0.040 wt %.

### Example 6

### Adhesion or Peel Strength

One-inch wide strips were cut from co-extruded tube constructions in the longitudinal direction. The layers were separated or attempted to be separated at the layer interface and pulled in a tensile tester at room temperature and 50% humidity in a “T-peel” configuration at a separation speed of 12 inches/minute (about 30 cm/min). The average force to separate the layers was divided by the width of the strip to give the peel strength reported in g/inch. Three or five separate determinations were made and reported as an average. If the layers could not be separated to start the test, then the result is reported as “CNS” or “can not separate” and indicates the highest level of adhesive bond. A peel strength value higher than 680 g/inch is considered adhesive.

The results in Table 3 show the FG-fluoropolymer composition of Example 1A has good adhesion (i.e. peel strength) to thermoplastics with amine functionality such as polyamide.

TABLE 3

| | | Average Peel Strength, |
|---|---|---|
| Layer 1 | Layer 2 | g/inch |
| Example 1A | PA12 | 721 |

The results in Table 4 show the FG-fluoropolymer compositions of Example 2 have good adhesion (i.e. peel strength) to thermoplastics with amine functionality such as polyamide.

TABLE 4

| | | Average Peel Strength, |
|---|---|---|
| Layer 1 | Layer 2 | g/inch |
| Example 2A | PA12 | 1,822 |
| Example 2B | PA12 | 1,066 |
| Example 2C | PA12 | 1,271 |
| Example 2D | PA12 | 1,198 |
| Example 2E | PA12 | 1,636 |

The results in Table 5 show the FG-fluoropolymer composition of Example 3 has excellent adhesion (i.e. peel strength) to thermoplastics with amine functionality such as polyamide.

TABLE 5

| | | Average Peel Strength, |
|---|---|---|
| Layer 1 | Layer 2 | g/inch |
| Example 3 | PA12 | CNS |

The results in Table 6 show the FG-fluoropolymer composition of Example 4 has good adhesion (i.e. peel strength) to polyesters.

TABLE 6

| | | Average Peel Strength, |
|---|---|---|
| Layer 1 | Layer 2 | g/inch |
| Example 4 | Crystar ® 4418 | Good |

The results in Table 7 show the FG-fluoropolymer composition of Example 5 has good adhesion (i.e. peel strength) to metal surfaces such as aluminum.

TABLE 7

| | | Average Peel Strength, |
|---|---|---|
| Layer 1 | Layer 2 | g/inch |
| Example 5 | Aluminum | Good |

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges include each and every value within that range.

What is claimed is:

1. An aqueous polymerization process for the manufacture of a fluoropolymer comprising repeating units arising from a perfluoromonomer and a hydrocarbon monomer having a functional group and a polymerizable carbon-carbon double bond, comprising:
(A) combining water and a perfluoromonomer to form a reaction mixture;
(B) initiating polymerization of said perfluoromonomer;
(C) polymerizing a portion of said perfluoromonomer to form particles of polymerized perfluoromonomer in said reaction mixture;
(D) adding to said reaction mixture a monomer having a functional group and a polymerizable carbon-carbon double bond, wherein all monovalent atoms in said monomer having a functional group and a polymerizable carbon-carbon double bond are hydrogen; and
(E) polymerizing said perfluoromonomer and said hydrocarbon monomer having a functional group and a polymerizable carbon-carbon double bond in the presence of said particles of polymerized perfluoromonomer to form said fluoropolymer.

2. The process of claim 1, wherein surfactant is further added to said reaction mixture and said reaction mixture comprises an aqueous dispersion.

3. The process of claim 1, further comprising heating said reaction mixture.

4. The process of claim 1, wherein said functional group is a carboxyl group.

5. The process of claim 4, wherein the pH of said reaction mixture measured at 25° C. is less than the pKₐ of the carboxylic acid corresponding to said monomer having a functional group and a polymerizable carbon-carbon double bond.

6. The process of claim 4, wherein said monomer having a functional group and a polymerizable carbon-carbon double bond comprises a monomer having a dicarboxylic acid group capable of forming a cyclic dicarboxylic acid anhydride and a polymerizable carbon-carbon double bond, and wherein the pH of said reaction mixture measured at 25° C. is less than the pKₐ₁ of said monomer having a dicarboxylic acid group capable of forming a cyclic dicarboxylic acid anhydride and a polymerizable carbon-carbon double bond.

7. The process of claim 4, wherein said reaction mixture further comprises a strong acid.

8. The process of claim 4, wherein said reaction mixture further comprises an acidic buffer.

9. A fluoropolymer made by the process of claim 1,
wherein said perfluoromonomer comprises at least one repeating unit arising from tetrafluoroethylene, hexafluoropropylene, and perfluoro(alkyl vinyl ether), and
wherein said functional group is at least one selected from the group consisting of carboxyl, amine, amide, hydroxyl, phosphonate, sulfonate, nitrile, boronate and epoxide.

10. The fluoropolymer of claim 9, wherein said fluoropolymer is semicrystalline and melt processible.
